(19) United States
(12) Patent Application Publication
(10) Pub. No.: US 2009/0017213 A1
(43) Pub. Date: Jan. 15, 2009

(54) METHOD FOR SPREADING A CONTINUOUS COATING FILM ONTO A SUBSTRATE TO BE PRINTED AND AN APPARATUS FOR IMPLEMENTING THIS METHOD

(76) Inventor: Luigi CASTELVIN, Verona (IT)

Correspondence Address: BROWDY AND NEIMARK, P.L.L.C.;624 NINTH STREET, NW, SUITE 300, WASHINGTON, DC, 20001-5303, US

(21) Appl. No.: 12/062,277

(22) Filed: Apr. 3, 2008

(30) Foreign Application Priority Data
Dec. 5, 2006 (IT) PD2006A000444
Nov. 6, 2007 (EP) 07120047.1

(51) Int. Cl. B05D 3/10; B05C 11/00

(52) U.S. Cl. 427/340; 118/600

(57) ABSTRACT

Method and apparatus for spreading a continuous coating film on a substrate to be printed, by supplying piezoelectric heads with components of a fluid product chosen from within the category comprising: a varnish, an enamel, a lacquer, a primer, a coating, a glue or similar products. Each component has a viscosity preferably in the region of 20 cP and density of about 0.6-1.3 g/cm³. The piezoelectric heads distribute the components on the substrate, producing mixing thereof and a polymeric polyaddition reaction able to form a coating film which is thin, resistant and uniformly distributed over the entire substrate.

### FIELD OF APPLICATION

The present invention relates to a method for spreading a continuous coating film onto a substrate to be printed and an apparatus for implementing this method.

The method and the apparatus in question are intended to be advantageously used industrially for covering substrates in the form of rolls, sheets or panels with a layer of coating product comprising a polymer resin, such as a varnish, an enamel, a lacquer, a primer, a coating, a glue or similar products.

The substrates thus treated have a backing or protective layer on which it is possible to provide writing, logos or images which are generally obtained by means printing processes performed with plotters having piezoelectric heads mounted on electromechanical systems for the application of inks using conventional techniques such as the so-called “drop on demand” technique.

Therefore, the present invention is classifiable within the industrial sector of graphics, decoration, paper and cardboard manufacturing technology and textiles and in particular within the sector relating to the production of display signs, panels, posters, PVC banners, synoptic panels, tiles, boxes, containers and fabrics bearing images, logos or writing or solid shapes for example of an advertising or decorative nature, having a large format, and intended to be exhibited both in open spaces and inside buildings.

### PRESENT STATE OF THE ART

As is known, the deposition of coating products in the graphics sector is necessary in order to satisfy a wide range of needs.

Varnishes, enamels and lacquers have the function of protecting with a solid and continuous film of uniformly distributed product the surface of the substrate containing writing, logos and designs from the action of rain, sun and atmospheric agents as well as the mechanical stresses resulting from cleaning with a brush or other friction means used in anti-vandal and chemical systems.

Enamels are, differently from varnishes, pigmented or coloured and therefore cover any imperfections on the surface of the substrate, while lacquers are again different from varnishes, being normally less transparent and less glossy.

The primer and coating have the function of preparing the substrate, so that it is suitable for receiving the subsequent printing treatment.

The application of a layer of primer makes it possible, for example, to perform four-colour printing on acrylic materials such as Plexiglas, polycarbonate or cotton onto which some inks would otherwise not adhere.

Glues have the function of preparing the substrate, making it suitable for combination, in a retaining relationship, with a second substrate such as, for example, a sheet or a film of paper or plastic or other material.

Hitherto these coating products were deposited by means of a spreading or deposition processes of the manual type, such as manual spreading using a brush, manual spreading with a roller, or manual spreading using compressed-air spray guns, airbrushes and aerosols, or of the mechanical type using industrial spreading machines of the roller, cylinder or spray type.

Both the manual and mechanical techniques use fluids which have a viscosity greater than 30 cP and with dissolved particles having dimensions of more than 8 microns because they thus achieve a covering density more quickly and easily.

Traditionally compounds such varnishes, enamels, glues, etc., generally consist of 2 components+solvent, where the first component consists of a base resin with a viscosity having an average value of 35 cps and the second component consists of crosslinking agents and/or drying agents with a viscosity having an average value of 3 cps and is added to the first base component in a volumetric percentage varying from a minimum value of 0.5% to a maximum value of 10%. Once the components have been combined in a single container, a quantity of solvent is added in an amount sufficient to reach the viscosity and drying time values suitable for manual or roller distribution of the product thus obtained.

The manual techniques have the drawback that they are time-consuming and involve high labour costs. Moreover, with these techniques it is not possible to achieve a constant quality which allows a high standardization of the properties of the treated substrate.

Industrial spreading machines of the roller type usually use a displaceable carriage which feeds the substrate between a series of rollers which are soaked with the products to be distributed so as to spread a uniform film thereof over the surface or surfaces of the substrate to be treated.

Spray machines envisage the use of a frame travelling on rails with several mounted guns able to spray by means of compressed air atomized liquid onto the surfaces of the substrates to be treated.

These apparatus also, although partly overcoming the problems of manual systems, in practice have proved to be not without drawbacks.

The main drawback of these apparatus consists in the high cost for initially setting up and maintaining them, which is justifiable only in the case of large production plants. A second drawback consists in the large dispersion of waste fluid into the air or into the washing systems. A further drawback consists in the fact that each of these machines is generally able to spread only one type of fluid product.

Also known are electromechanical apparatus (plotters) which are able to print, by means of piezoelectric heads, so-called fixed inks in four colours or six colours using known ink printing techniques referred to in the sector in question as the “drop on demand” method.

The printing of images or designs in different shades and combinations of colours is performed, as is known, by means of the distribution and essentially subtractive mixing of fixed inks. The inks are referred to as being “fixed” because they are present in a fixed number of four in four-colour printing (C, M, Y, K) Cyan, Magenta, Yellow and Black and six in 6-colour printing (C, c, M, m, Y, K) Cyan, Light Cyan, Magenta, Light Magenta, Yellow and Black.

These inks are semi-transparent and the superimposition thereof creates a very wide range of colours able to provide images which have an excellent quality by means of subtractive mixing (each ink and its mixture subtracts, according to the area covered, light from the white of the paper, producing a very large number of shades of colour).

Each of these fixed inks occupies physically a piezoelectric head. Therefore, in the case of four-colour printing the minimum number of heads present is four and in the case of six-colour printing the minimum number is six.

In greater detail, the firmware of the plotter performs the reproduction of printed images by means of grids of dots for the individual colour channels (“rosettes” consisting of several droplets), which have a varying size or concentration. More clearly, in order to distribute the space between filled and empty areas, essentially two solutions are possible: printing dots of varying size, with their centres all at the same distance, or printing dots with the same size, but at variable distances from each other.

In the first case the traditional screening method is used, while in the second case the so-called “stochastic” or FM (Frequency Modulation) or random method is used.

Adjustment of the tones is performed, in the now most common case, by means of grids with stochastic screening which reconstructs the tones by means of variation, in each unit of surface area considered, of the number of microdots created.

The shades of colour in a printer are also expressed with four numbers each ranging from 0 to 100, indicating the percentage of ink CMYK in that precise point.

The firmware and software used in these apparatus therefore envisage that the heads distribute the ink droplets in the four channels as grids using stochastic screening so as to deposit a greater or smaller number (greater or smaller concentration) of droplets per unit of surface area.

The surface of the substrate is therefore not covered by a full and continuous film, but only by a more or less dense distribution of droplets using the so-called “drop on demand” technique, while continuing to maintain large free areas between the abovementioned droplets.

As is known, offset printing machines and plotters process the images which are supplied in various formats (bitmap, vector, .jpeg, .bmp, etc.) in order to produce for each colour channel a distribution grid (raster) by means of which the colour is released or not in the form of droplets at points of the grid defined using binary logic states. This process is otherwise referred to by the abbreviation “RIP” (Raster Image Processing).

With conventional screening, the grids of the individual colours are angled relative to each other in order to prevent the repetitive pattern being perceived by the human eye as unattractive streaks.

With the more recent use of stochastic screening, which introduces a random component into the arrangement of the colour droplets, the problem of streaks being noticeable due to the repetitive distribution of the fixed inks in four-colour or six-colour printing has been overcome.

The term “drop on demand” is commonly used in present-day official documentation to define the printing technique which, using piezoelectric heads, allows the heads to be electrically controlled depending on the tonality of the image which they must create and print, the tones thereof being reconstructed and printed by variation, in each unit of surface area considered, of the number of microdots created which is expressed as a percentage ranging from 0% to 100% density and which are arranged by means of stochastic screening using special deposition methods (patterns or screens).

Tone modulation is performed, as mentioned, by means of the use of a firmware which produces a RIP in which the screens are of the stochastic or random type so as to avoid the superimposition of the colours in a repetitive manner which may be perceived by the human eye as streaks (moiré effect) during superimposition of the fixed inks in four-colour or six-colour printing.

During generation of the print files (grids of binary logic states for each point and ink channel) or during rasterization of the image it is known to take into account the materials of the substrate for printing or the type of ink or also the need to obtain particular graphic effects (as well as avoid the moire effect) using patterns which modify the distribution of the droplets in order to obtain the desired effects.

The modifications made to the stochastic approach have resulted in increasingly better patterns. Each RIP manufacturer uses different names to describe the specific variations of the stochastic pattern. In order to obtain the best print quality, it is necessary to use the best diffusion pattern possible within the RIP software available, selecting it for example depending on the material of the substrate or the graphic effect which is to be obtained.

As mentioned above, in printing processes it is known to treat the desired graphic substrate both before and after printing using varnishing processes. In particular, after printing, varnishing operations designed to ennoble the printed product are known, the aim being to modify and embellish the print by modifying the finish, highlighting details, etc. Varnishing is also used for the technical function of improving the characteristics of a printed article, for example increasing its mechanical strength, chemical resistance or resistance to UV radiation, or accentuating gloss or mat effects. Normally transparent products comprising UV, acrylic, polyurethane or other kinds of varnishes such as water-based varnishes are used, these being deposited using the manual or mechanical techniques mentioned above. Some varnishes contain additives which allow filtration of UV rays so that the printed article is resistant for a long time in an external environment. These varnishes are normally solvent-based. The varnish for overprinting often has a base common to that used for the manufacture of inks. If we consider, for example, a solvent-based varnish, we can see that it is composed of a resin, a solvent and a series of additives. A solvent-based ink also contains a resin, a solvent, similar to those of the varnish with the addition of pigments which give the ink its colour, and additives for facilitating coverage. The varnishes used for printing, with their transparency and brilliance characteristics, therefore have a formula which often constitutes the initial state of an ink and therefore reference is made to both a solvent-based product and to a UV polymerization product. UV varnishing of an offset printed article, by means of protective overprinting for treatment aimed at maximising the resistance of the ink, may be glossy or mat. The duration and resistance of the varnish may be high in order to protect articles to be mounted externally such as theatre placards, posters, boards for display signs. Commercially, however, there exist a greatly varying range, in terms of use and duration, of solvent-based or UV products. A solvent-based varnish may be incompatible with water-based inks.

In the market different formulations of varnishes used in printing processes are known. These include for example: polymer resins based on acrylic ester used for plasticizing nitrocellulose and improving the adhesion to various substrates (in particular suitable for the production of inks for photogravure); vinyl chloride and vinyl isobutyl ether polymer resins suitable as binders for photogravure inks with a good adhesion on PE/OPP; anti-radiation resins for coatings such as epoxy acrylates, polyether acrylates, urethane acrylates and functional monomers; used in combination they impart specific qualities to the coating; acylphosphine photoinitiators for pigmented UV coatings; colourless aldehyde ketone resins which have a good compatibility and solubility in organic solvents and are suitable for use in pigmented pastes and as co-binders in various coating systems with hardness, brilliance and rheology properties; saponification-resistant plasticized resins based on polyvinyl ethers for improving the flexibility and adhesion of the printing inks and varnishes; polyisocyanate resins and amino-resins or resins for plasticizing binders which improve the adhesion on various substrates; styrol-acrylic resins with formation of films at various temperatures used for coating steel and non-ferrous metals, with anti-corrosion properties; polyisocyanate hardening resins based on allophanatized, isocyanuratized or biuretized hexamethylene diisocyanate (HDI) and/or trimerized isophorone diisocyanate (IPDI) which are used for 2K polyurethane surface coatings, are impermeable and have a light fastness, as well as primers for difficult substrates; aliphatic and cycloaliphatic amine hardening resins for solvent and water-based epoxy coatings, which may be used separately or as components in a formulation; amino-resins are used in acid-curing paints; they are used mainly in combination with other binders to produce particularly glossy paints which are resistant to atmospheric agents, yellowing and chemical agents; rigid and plasticized urea-formaldehyde resins, depending on their composition may be used to formulate both solvent-based and water-based systems which are used in particular to produce paints which, owing to the additional effect of the co-binder, are more adhesive, flexible and stable than melamine-formaldehyde resins; anti-radiation monomers and binders, combinations of epoxy acrylates, polyester acrylates, polyether acrylates, urethane acrylates and functional monomers produce coatings with specific characteristics; carbamide resin for binders containing nitrocellulose and chlorine, which improves the elasticity, brilliance and ageing resistance.

### DISCLOSURE OF THE INVENTION

In this situation, the main object of the present invention is therefore to eliminate the drawbacks of the solutions of the abovementioned known conventional type, by providing a method for spreading a continuous coating film on a substrate to be printed and an apparatus for implementing this method, which allow distribution of the abovementioned product in a easy, practical and low-cost manner.

Another object of the present invention is to provide an apparatus for spreading a continuous coating film on a substrate to be printed, which is operationally safe and entirely reliable.

Another object of the present invention is to provide an apparatus for spreading a continuous coating film on a substrate to be printed, which can be used in a versatile manner to distribute fluid products both before and after printing and with different characteristics.

Another object of the present invention is to provide an apparatus for spreading using the “drop on drop” technique a continuous coating film on a substrate to be printed, which can be used in a versatile manner to distribute fluids with different characteristics greater in number than the number of print heads available.

### BRIEF DESCRIPTION OF THE DRAWINGS

The technical features of the invention, in accordance with the abovementioned objects, may be clearly determined from the contents of the claims indicated below and the advantages thereof will emerge more clearly from the detailed description which follows, provided with reference to the accompanying drawings which illustrate a purely exemplary and non-limiting embodiment thereof, in which:

FIG. 1 shows an overall perspective view of a first embodiment of the apparatus for spreading a continuous coating film on a substrate, in accordance with the present invention;

FIG. 2 shows an overall perspective view of a second embodiment of the apparatus according to the invention;

FIGS. 3 and 4 shows an enlarged detail of the apparatus according to FIG. 4 in two perspective views, i.e. a front view and a rear view, relating to a print head carriage;

FIGS. 5A and 5B show details of the apparatus according to FIG. 1 (modified with 4 print heads) and relating to tanks for discharging components of the product to be distributed.

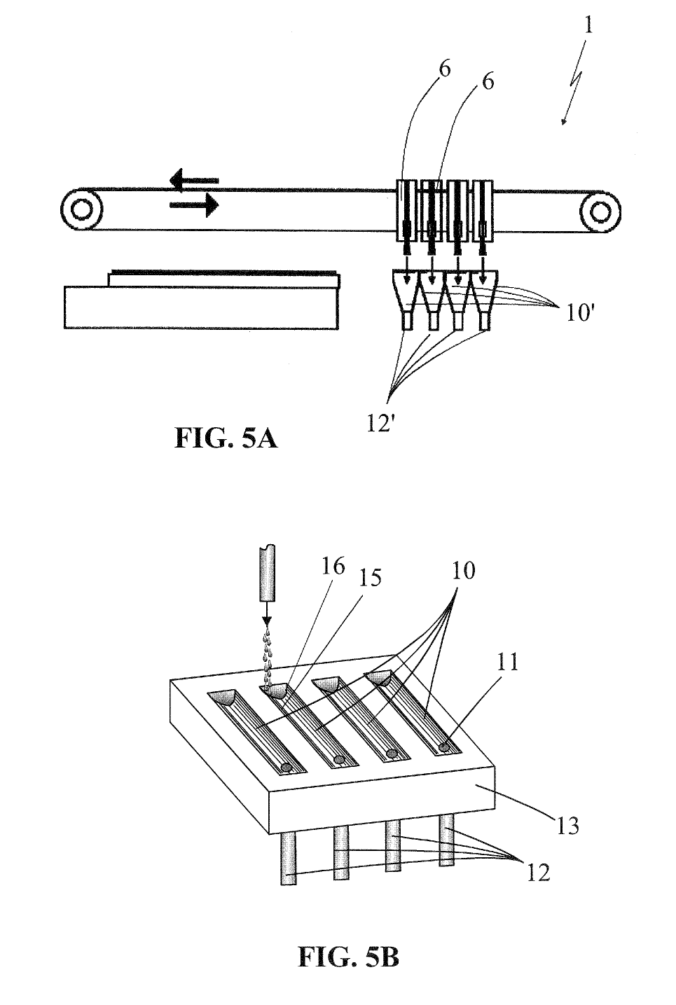

### DETAILED DESCRIPTION OF A PREFERRED EXAMPLE OF EMBODIMENT

With reference to the attached drawings, 1 denotes in its entirety the apparatus for spreading a continuous coating film on a substrate to be printed, such as, for example, a sheet or panel made of paper, cardboard, plastic, PVC, etc.

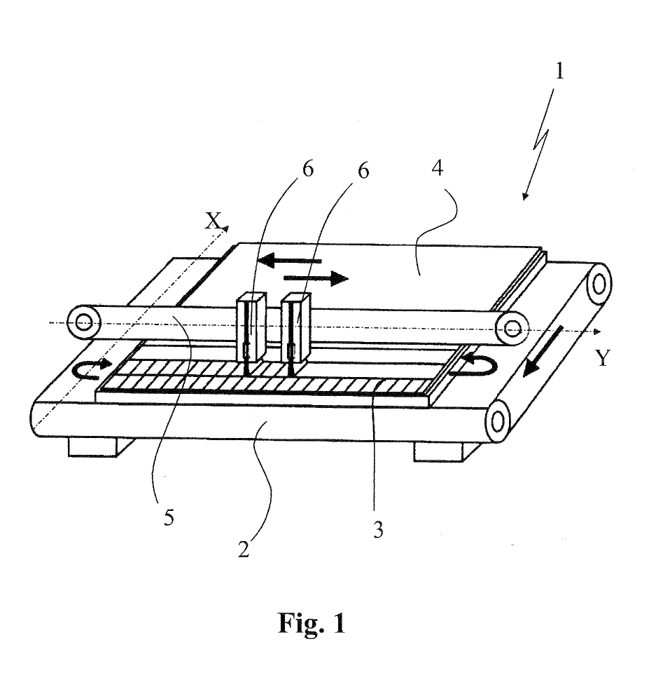

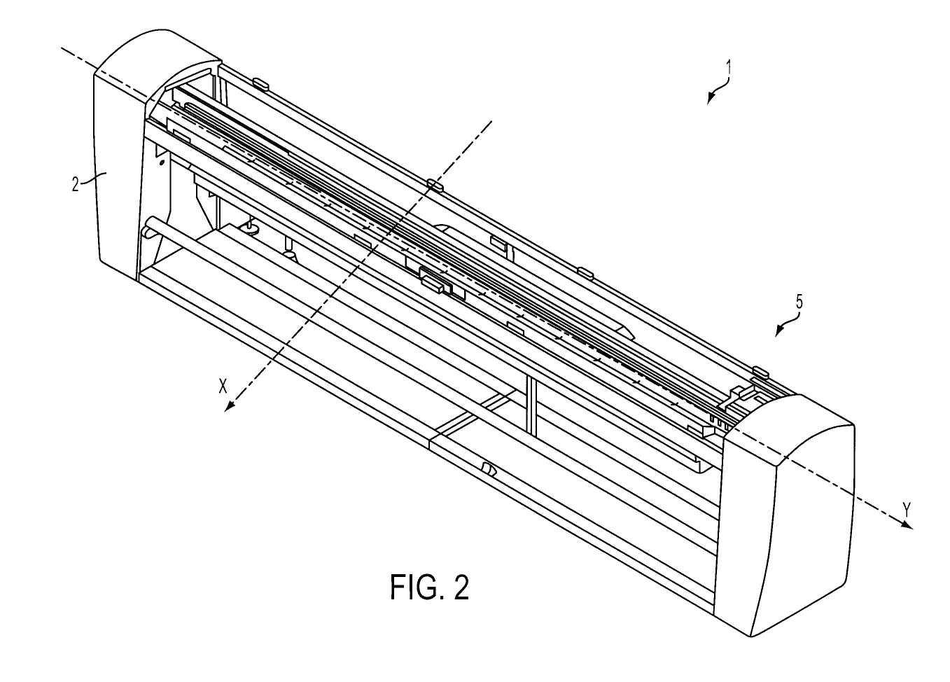

FIGS. 1 and 2-4 show schematically two different types of apparatus according to the invention. The first figure relates to an apparatus in which the substrate is fixed and only a carriage with heads 6 for distributing the product moves in both directions along mutually perpendicular axes, while in FIGS. 2 and 4 the apparatus according to the invention is substantially formed by a digital printing machine or consists of a modified plotter which therefore involves the transverse displacement of the carriage 5 and the longitudinal feeding of the substrate in the form of a sheet which is advantageously unwound from a roller situated upstream of the apparatus.

In both solutions, the apparatus comprises a support structure 2 which rests on the ground and supports a receiving surface 3 on which substrate 4 to be treated, for example consisting, as mentioned, of a sheet or a panel, is placed.

At least two heads 6, of a digital printer or plotter, in particularly preferably of the piezoelectric type, are envisaged, being mounted on a movable carriage 5 which is operated so as to be displaced with a relative movement with respect to the substrate 4 along mutually perpendicular axes X, Y so as to cover the entire area of the substrate 4.

In greater detail, with reference to the embodiment according to FIG. 1, the carriage 5 extends in the form of a bridge between two opposite and parallel sides of the same surface 3 where it engages in two rails of the support structure 2. The carriage 5 can be operated to move by first driving means along these rails so as to travel in a direction of forward movement X. The carriage 5 is therefore provided with two or more piezoelectric heads 6 which can be operated so as to move along the axis Y of the carriage perpendicular to the axis X by means of second driving means. In the case of materials in roll form to be treated, the movement of the carriage along the axis X may be replaced by a pair of counter-pressure rollers able to feed the roll-type substrate between them, the bottom roller having driving power and the upper roller remaining free, but pressed against the other roller. Rollers for unwinding and receiving the sheet-like substrate are provided at the rear of and in front of the apparatus.

The apparatus according to the invention in the various embodiments shown implements operationally the method described hereinbelow for spreading a continuous coating film over the substrate 4.

Initially it is necessary to define the components of the dual or multi-component film-forming product which is to be spread over the substrate, whether it be a varnish, an enamel, a lacquer, a primer, a coating, a glue or similar product. The product to be spread over the substrate 4 will be chosen in accordance with its functional characteristics and may be distributed on the substrate 4 both prior to printing or after printing or on top of the print.

In any case the product to be spread consists of a mixture of components comprising at least two components reacting chemically with each other. In greater detail, a first component, which is present in a much greater quantity compared to the other components (more than 70%), forms the basis of the product and is formed by a resin chosen from the category comprising vinyl, acrylic and polyurethane resins or similar resins. This resin is dissolved in a solvent of the ketone, ester and glycol ether type, or similar solvents. This component will be stored in a first container (advantageously corresponding to an ink tank of a printing machine or plotter for example equipped with 4 or 6 tanks for four-colour or six-colour printing) and will be in form of a fluid with a viscosity in the range of 7-24 cps (and preferably about 20 cps) and density in the range of 0.6-1.3 g/cm³ (and preferably about 1.0 g/cm³).

At least one second component is also present, being stored inside a second container (advantageously corresponding to the ink tank of a printing machine or plotter) and will be in the form of a fluid with a viscosity in the range of 7-24 cps (and preferably about 20 cps) and density in the range of 0.6-1.3 g/cm³ (and preferably about 1.0 g/cm³).

The two components are conveyed via respective pumps, arranged so as to intercept respective separate channels connected to the containers, to two corresponding separate heads 6 of the digital printing machine or plotter, which are mounted on the movable carriage 5 which is made to move with a relative movement with respect to the substrate along mutually perpendicular axes X, Y.

At this point it is operationally envisaged performing spreading of the components on the substrate 4 by means of the heads 6. This spreading action is achieved with print files obtained with an RIP which envisages a raster for each channel with full coverage in the range of 85-100% for each component. In this way, the heads deposit with one or more successive passes by means of a plurality of adjacent droplets two substantially superimposed layers (but they could also be three or more in the case of products comprising several components to be distributed each with a separate head) which are uniform and continuous and are able to produce subsequent thorough mixing together thereof on top of the substrate. Essentially rasterization is performed by indicating for the individual channels of the components (equivalent to the colours during normal operation of the plotter) full colour areas so as to produce grids for distribution of the individual components with total or near-total coverage of the substrate.

Owing to the present invention the components of the film-forming product to be distributed are mixed downstream of the print heads directly on the substrate. Advantageously, the individual components may be stored in the respective containers for a very long period of time without reacting.

Once they have been spread on each other and then mixed, the components of the film-forming product mixture give rise to a consequent and subsequent chemical reaction with the polyaddition of the first component and subsequent drying of the mixture so as to form a continuous coating film on the substrate 4.

Therefore, the polymerization by means of polyaddition, after spreading of the components, is performed directly on the receiving surface of the substrate.

It should be pointed out that, in accordance with the art known hitherto, mixing of the components of the mixture in the quantities envisaged by the stoichiometric ratio was performed by mixing together the components before they were distributed on the substrate, and particular importance was not attached to the values for viscosity, fluidity and drying speed of the individual components since the manual and mechanical apparatus (rollers) which were used for distribution thereof with spreading of the mixture, were able to accept an extremely wide range of values.

In order to distribute, instead, the same product for example with two components using piezoelectric heads of a digital printing machine or a plotter, it is necessary to determine beforehand viscosity, fluidity and drying speed values of the individual components so as to ensure discharging thereof from the heads. Moreover, it is necessary to arrange the heads at a sufficient distance from the substrate so that the droplets, when deposited on the layer, form a base of unfocussed dots so as to favour the intermingling thereof, in particular in the case of less than 100% coverage (differently from that which occurs in four-colour printing where the focus is centred on the substrate) and, if they are deflected, are not deposited on the adjacent heads such they mix with other components and cause a reaction which blocks the heads.

In order to standardize and adapt the viscosity, fluidity and drying speed parameters it is necessary to combine the first resin-based component with a solvent which generally lowers the viscosity to values preferably close to 20 cps and then generally proceed to add thickening agents to the other components (catalyst, crosslinking agent, hardener) in order to adjust the viscosity preferably again to 20 cps.

The reagents (catalyst, crosslinking agent, hardener) may be more than one. Usually each reagent is sued to impart a specific resistance to the polymer produced, i.e. resistance to alcohol, scratching, atmospheric agents, detergents, solvents and UV rays.

It is possible to envisage the use of three or more heads in order to distribute a greater number of reagents by means of specific heads. For example, it was possible to observe experimentally that it is advantageous to use a third head in the case where it is required to use as a crosslinking agent an isocyanic reagent since the latter, catalyzing with the air moisture present in the hydraulic circuit, would cause malfunctioning of the head if not used in combination with a specific solvent which is namely fast-acting and insensitive to moisture. Obviously this third component must generally be mixed with a suitable quantity of thickening agent which is not affected by the reaction in order to provide it with the viscosity envisaged (about 20 cps) so as to allow the piezoelectric head to function correctly.

The components must be of a number such as to reproduce the stoichiometric ratios for producing a correct polymeric reaction. Below various methods for spreading the components in their corresponding stoichiometric ratio necessary to ensure the correct polyaddition reaction will be described.

The digital printing machine or plotter performs preferably rasterization of the image files which are sent to it in order to determine the distribution of the components with the heads 6, in particular envisaging a distribution of the single components with stochastic screening preferably in the form of a screen able to distribute quickly and uniformly the components on the substrate.

In greater detail, the components are distributed using print files having a raster with substantially 100% spread over the substrate. Spreading of these components may be adjusted for each channel by reducing the coverage to about 80% without an appreciable lack of uniformity.

In other words, the resin-based components are distributed in unfocussed droplets arranged alongside each other so as to fill correctly both 80% and 100% of the surface. The first resinous component also forms preferably the first layer in contact with the substrate and its percentage within the mixture is preponderant and exceeds 70% of the entire product.

The further layers of the crosslinking and hardening components must be deposited thereon by means of the other separate piezoelectric heads. These layers may also be distributed in percentages slightly less than 100% and preferably not below 80% without this adversely affecting the reaction. In fact, the droplets of uniformly distributed unfocussed components although not covering the entire surface may equally well spread uniformly over the substrate covering the entire area or allowing a complete reaction of the entire surface.

This adjustment of the percentage of reagent product (second and third component) distributed by the heads will allow, for example, calibration of the stoichiometric percentage ratio of the components without the need to modify its formulation by varying the solvent or the thickening agent.

Advantageously, in order to prevent excessive dilution of the crosslinking components and hardeners which then determine excessively long drying times, the throughputs of the associated piezoelectric distribution heads may be conveniently less than the throughput of the piezoelectric head for the first resinous base component.

For example it is possible to envisage spreading the first resinous component with 100% coverage using an 80 pl piezoelectric head and spreading the two envisaged additional second and third components in percentages of around 5% of the first component, with 100% coverage obtained with a 50 pl piezoelectric head, after suitable mixing of the quantities of 5% reagent in a compound comprising solvents and inert thickening agents which do not participate in the polymerization reaction.

As mentioned, the method and apparatus according to the invention allow distribution by means of one or more piezoelectric heads of one or more fluid components, in particular monomer components, the polyaddition polymerization reaction of which, after spreading thereof, occurs directly on the receiving surface of the substrate. Each fluid component may be deposited with one or more piezoelectric heads both of the fixed dot and variable dot type. The difference between the fixed dot heads and the variable dot heads lies in the volume of fluid emitted by the single droplet propelled by the piezoelectric system which is constant in the case of fixed dot heads, while it may vary with up to 8 volume levels in the case of variable dot heads. The fixed dot heads which may be used in the present invention operate preferably with volumes of between 30 and 80 pl, while the variable dot heads operate with 8 volume levels which vary from 6 to 13 pl.

Therefore, the adjustment of the quantity of the individual components in order to obtain the precise stoichiometric ratio may be obtained, apart from using heads with varying throughputs, also with varying degree of dilution of the components and with varying percentage distribution on the surface (in any case greater than 80% of the coverage) also using heads with several distribution levels.

Each piezoelectric head 6 is supplied by means of a micropump with a component in fluid form having a maximum dimension of the particles dissolved therein of less than 8 microns.

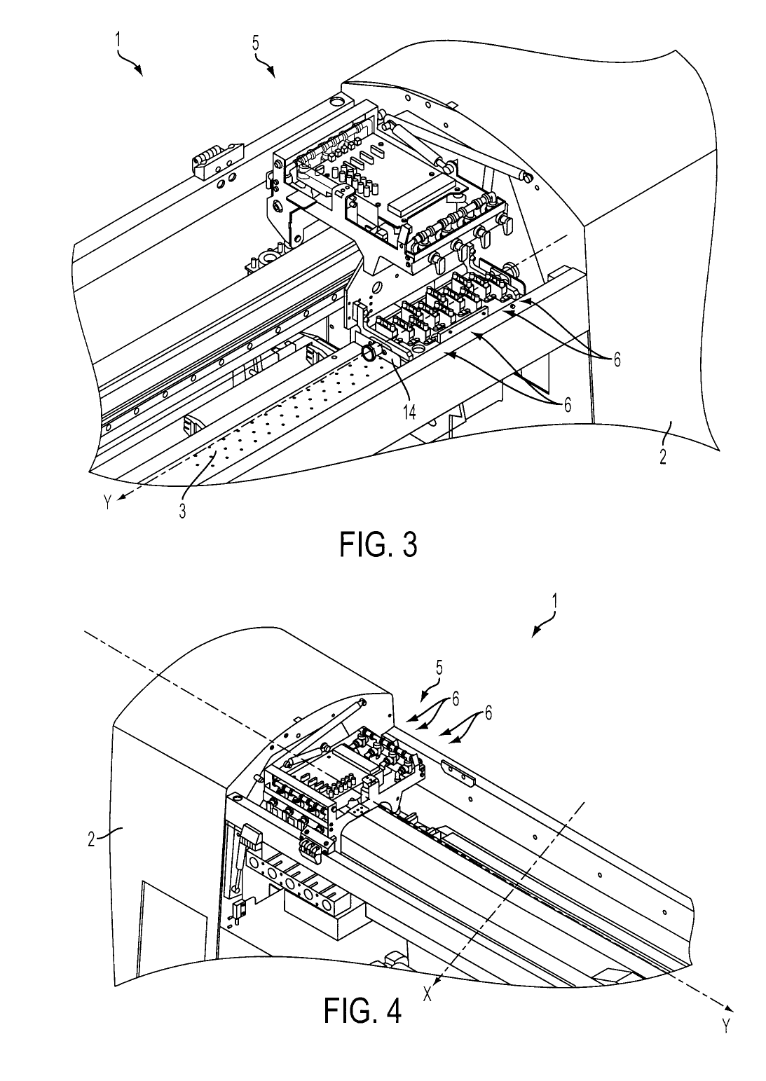

One end of the apparatus shown in FIGS. 2 to 4 is provided with discharge tanks 10 which are equal in number to the components and are formed on a metal base 13 with longitudinal grooves having an inclination towards a discharge hole 11 connected to a discharge pipe 12. The tanks 10 and the pipes 12 are separate from each other so as to receive the components without mixing them during cleaning, namely when the printer is inoperative. With reference to the attached figures, this metal base 13 may be arranged at the other end of the carriage travel path to that shown in FIG. 3, by analogy in place of the stopping unit indicated by number 14. Preferably, the groove 15 has a wall 15 which is broader than the other wall 16 so as to allow the stream of fluid product to be guided thereon, causing it to adhere with a not very pronounced angle of incidence in order to prevent splashing which would result in mixing of the components with consequent undesirable reactions.

The other end of the apparatus shown is FIG. 1 is also provided with discharge tanks 10′ which are equal in number to the components, and the associated pipes 12′ are separate from each other so as to receive the components without mixing them during cleaning or when the printer is inoperative.

The film of polymerized product which will be spread over the substrate will be extremely uniform and have a constant and very limited thickness, for example of about 0.0025 mm or multiples thereof in the case of several layers.

The apparatus 1 also has a logic control unit for controlling in predetermined operating sequences the movement and activation of the piezoelectric head 6 and the carriage 5 as well as a firmware configured to deposit, with several successive passes by means of a plurality of droplets arranged in adjacent rows, the single components so as to form substantially uniform and continuous multiple layers on the substrate 4.

The software or firmware for moving the carriage and operation of the heads are not described in detail since they are entirely known to a person skilled in the art accustomed to use digital printing machines or plotters.

In general the invention uses for spreading liquid components an electromechanical apparatus for controlled movement along X and Y axes, in which the micropumps are activated by means of electric commands so as to allow the piezoelectric heads 6 to spray small droplets of liquid onto the surface of the substrate 4 to be treated.

The two axes perform, via the software, alternating and synchronized movements so that their combination produces a series of adjacent bands until the entire surface thereof is covered.

In greater detail, in accordance with the accompanying figure, each head has 3 emission parts each having three rows of aligned nozzles with overall 185 nozzles per part so as to emit rows of droplets of components of the product which are slightly spaced from each other owing to the physical distance existing between the nozzles. The droplets of product are then interpolated in order to obtain complete filling of the surface to be treated with further movements of the head aimed at releasing by means of the nozzles in a position offset with respect to the first position new rows of droplets for filling the space between the previous droplets and therefore totally covering the surface.

The head may move not only so as to perform stochastic screening but also only along mutually perpendicular axes in order to achieve total coverage of the surface.

Control over the sprayed distribution of the droplets may also be managed by a firmware again in a stochastic manner as in conventional plotters, but now envisages spreading all the layers in a substantially continuous and uniform manner up to 100%.

Therefore, according to an important difference with respect to normal operation of plotters for four-colour printing, the present apparatus does not perform any reprocessing of the image intended to define a stochastic screen for deposition of the product with distribution of the droplets having empty spaces close to filled spaces for the individual channels, but instead, by making use of the resolution of the heads, is able to determine the slightly unfocussed distribution of very thin, complete, covering layers which give rise, owing also to the small dimensions of the droplets, to very thorough mixing and intermingling of the components directly on the substrate and not beforehand inside an external container according to the current mechanical roller or manual brush deposition techniques.

In other words, the present apparatus does not have to perform processing of the image (RIP) in order to adapt the resolution of the image to the resolution of the heads or in order to define a particular distribution pattern of the droplets, it being essentially necessary to define only a distribution grid substantially able to distribute completely the individual components over the area to be covered.

The term “drop on drop” is a new expression coined with the description of the present invention in order to make a distinction from the expression commonly used in inkjet printing. It is used to describe a different method of using the piezoelectric heads employed, which in this case must achieve complete, i.e. substantially 100% coverage of the surface of the substrate to be treated. The full and continuous coverage with uniformly distributed product thus defined is achieved by means of a firmware which produces geometric screening with a single or double pass using piezoelectric heads.

With this novel apparatus it is possible to control and perform specific metering of the products achieving considerable savings in consumption levels compared to conventional systems. Moreover, this apparatus prevents an excessive dispersion into the air of the products during their controlled dispersion by means of the heads 6 since the distance of the nozzles of the latter from the surface of the substrate 4 is in the region of a few millimetres (for example only 5 mm compared to the 2 mm in 4-colour printing). Therefore, the droplets, although projected in a slightly unfocussed manner from the nozzle, is not dispersed into the air as instead occurs in conventional spraying systems.

Therefore, the apparatus according to the present invention, while using part of the technology which is used in digital printing machines, with the “drop on demand” inkjet method”, to be considered known for a person skilled in the art and for this reason not described in detail, differs from these machines (plotters) owing to the use of the liquid products mentioned above and never used with this apparatus. Moreover, the apparatus according to the present invention envisages the distribution, using the “drop on drop” technique, of all the products using a method which is different from “drop on demand” distribution of the inks, in order to obtain a full uniform and continuous distribution, and not a distribution of the droplets with empty spaces and filled spaces in order to achieve all the possible shades of the colours.

The fluid components of the products used in the apparatus according to the present apparatus, namely varnishes, enamels, lacquers, primers, coatings, glues or similar products, differ from those which are currently used for the distribution of these products by means of traditional mechanical (roller type) systems in terms of the viscosity, density and drying speed (100 s from powder). Conventional products normally have a viscosity greater than 30 cP and have dispersion particles with dimensions greater than 15 microns. Moreover, these products have a drying speed which may require more than one hour in order to allow the fluid to be dispersed over the surface so as to prevent the streaking effect due to application by brush or the varying uniformity in the case of compressed-air spraying. Differently, the products used in the apparatus and in the process according to the invention have a maximum viscosity of 20 cP and do not have particles which are bigger than 8 microns. Moreover, the drying speed owing to the excellent uniformity and fineness of the film deposited or in particular owing to the use of dual- or multi-component products is equivalent in the case in question at the most to 3 passes or a few minutes since this is necessary for subsequent handling.

Advantageously, several tanks for fluid products of the type specified above may be envisaged, these being able to supply selectively by means of a system of electric valves and converging connectors the head or the heads of the apparatus, which are less in number than the tanks.

In the case where two piezoelectric heads 6 are used, numerous operational advantages, including a very short drying time, are achieved. With this new technology it is possible to control and perform the separate metering of the dual-component product, with mixing of its droplets, directly on the final surface to be treated.

The droplet produced by the second head is deposited and distributed with extreme precision on the layer produced by the previous head, thus achieving mixing of the dual-component fluids directly on the surface of the product.

In greater detail, the precise screening used by the heads 6 allows extremely efficient mixing of the two components directly on the surface of the substrate 4 to be treated. This distribution is made possible by the RIP produced by the printing machine which, during projection of the droplet from the second head 6 onto the layer already deposited by the first head 6, will ensure the correct position and quantity of products (correct stoichiometric ratio) at every point so as to control the polyaddition process and drying of the two components. This process is innovative since, in the conventional processes, the two components were mixed in a proportional manner in the tanks of the rolling machines prior to rolling, while the apparatus according to the present invention envisages performing mixing after spraying of the second head 6 and therefore directly on the surface of the substrate 4.

The advantage of this novel feature consists in that, inside the tank of each head 6, the liquids are separate and therefore are not subject to rapid drying such that they may be stored for a very long time. Instead with the conventional technique it was necessary to clean constantly the tanks of the machines in order to prevent blockage of the ducts and nozzles in the event of the operator being distracted.

One of the components may advantageously act as a catalyst for accelerating the reaction and/or drying of the product.

This catalyst, owing to the dot-like distribution of the components according to the invention in very fine droplets, facilitates reactions which under normal conditions would not be able to develop properly.

The aims achieved by this invention are described hereinbelow.

Savings in the amount of liquid components used since, owing to the deposition technique adopted by the piezoelectric heads on the surface of the substrate to be treated, only the quantity of components strictly necessary may be used, differently from the conventional techniques involving spreading by means of a roller (rolling) or using spray guns.

Ecological conditions of the production environment since the use with a very small distance (maximum 5 mm) between the jet head nozzles and the substrate prevents the dispersion in the air of waste dust from the process, as instead occurs in the conventional systems.

Greater flexibility of production possible with the process and the apparatus according to the invention, which allow the treatment of special products or limited or personalized series of substrates which could not be conveniently treated using the present systems which involve a greater amount of waste material generated during large-scale industrial production.

Economy of scale as regards the costs of preparation and maintenance of the equipment and liquid solvents used for cleaning the parts.

Mixing of the liquid products or dual-component catalysing fluids which, being performed as the droplets, results in much shorter reaction and drying times compared to those required by current techniques.

Mixing directly on the final surface of the droplets deposited results in optimum spreading which is more uniform and finer that that obtained conventionally and without incurring the associated cleaning and maintenance costs necessary for efficient upkeep of the apparatus used nowadays. With conventional apparatus there are in fact high costs for ensuring the clean condition and efficiency of the machine parts which come into contact with the liquids, such as rollers, spray guns, tanks, etc.

The invention thus conceived therefore achieves the predefined objects.

Obviously it may assume in its practical embodiment also forms and configurations which are different from that illustrated above without thereby departing from the present scope of protection.

Moreover, all the details may be replaced by technically equivalent parts and the dimensions, forms and materials used may be of any nature according to requirements.

1. Method for spreading a continuous coating film on a substrate, characterized in that it comprises the following operating steps:
a step involving the provision of:
at least one first component of a film-forming product, inside a first container, in the form of a fluid having a viscosity in the range of 7-24 cps, density in the range 0.6-1.3 g/cm³, and formed by at least one resin chosen from the category of vinyl, acrylic and polyurethane resins, dissolved in a solvent of the ketone, ester or glycol ether type;
at least one second component of said film-forming product, inside a second container, in the form of a fluid having a viscosity in the range of 7-24 cps, density in the range of 0.6-1.3 g/cm³, and formed by at least one crosslinking agent or hardener of the isocyanic or amino type;
a step involving supplying said first and second components, via two separate channels supplied by said containers, to two corresponding heads of a digital printing machine or plotter, which are mounted on a movable carriage operated so as to be displaced with a relative movement with respect to said substrate along mutually perpendicular axes;
a step involving spreading said components on said substrate by means of said heads operated with print files having a spreading raster for each channel with spatial coverage in the range of 80-100% so as to perform deposition, in particular in a slightly unfocussed manner, with one or more successive passes by means of a plurality of adjacent droplets; said heads depositing two substantially superimposed, uniform and continuous layers able to give rise to mixing and intermingling thereof on top of the substrate;
a step involving a polymeric chemical reaction where said components are mixed by means of polyaddition of the first component with the second component and subsequent drying of the mixture in order to form a continuous coating film on said substrate.

2. Method according to claim 1, in which it is envisaged providing a third component of said film-forming product, inside a third container, in the form of a fluid having a viscosity in the range of 7-24 cps, density in the range of 0.6-1.3 g/cm³ and formed by at least one crosslinking agent or hardener of the isocyanate or amino type; and in which it is envisaged supplying said third component, via a third channel, to a corresponding separate head of said digital printing machine or plotter, mounted on said movable carriage and operated with print files having a spreading grid with coverage in the range of 80-100% able to deposit, with one or more successive passes by means of plurality of adjacent droplets, a further layer able to be mixed with the other two components so as to participate in the chemical reaction.

3. Method according to claim 1, in which each said head is of the piezoelectric type.

4. Method according to claim 1, which envisages a rasterization step performed by the software of said printing machine in order to deposit the individual components, in particular with screening of the stochastic type and with the use of a screen intended to distribute quickly and uniformly the components on said substrate.

5. Method according to claim 1, in which the first component is distributed with print files having a raster for substantially 100% spreading on the substrate and the successive components are distributed with spreading rasters for each channel with coverage in the range of 80-100%.

6. Method according to claim 1, in which the mixture is distributed in a stoichiometric ratio defining different throughputs for the heads of the associated channels, the head for distribution of the first component having a greater throughput than the other heads.

7. Method according to claim 1, in which the mixture is distributed in a stoichiometric ratio by adjusting the solvent in said components.

8. Method according to claim 1, in which the percentage of first component inside said mixture is greater than 70%.

9. Method according to claim 1, in which the dimensions of the particles dissolved in said components do not exceed the dimensions of 8 μm.

10. Apparatus for spreading a continuous coating film on a substrate, characterized in that it comprises:
at least two piezoelectric heads of a digital printing machine or plotter which are supported by a movable carriage mounted slidably on a support structure defining a support for a substrate to be treated; said carriage being operated so as to be displaced with a relative movement with respect to said substrate along mutually perpendicular axes; a first head being able to distribute at least one first component of a film-forming product from a first container, in the form of a fluid having a viscosity in the range of 10-28 cps, density in the range 0.6-1.3 g/cm³, and formed by at least one resin chosen from the category of vinyl, acrylic and polyurethane resins, dissolved in a solvent of the ketone, ester or glycol ether type; a second head being able to distribute at least one second component of said film-forming product, from a second container, in the form of a fluid having a viscosity in the range of 7-24 cps, density in the range of 0.6-1.3 g/cm³, and formed by at least one crosslinking agent or hardener of the isocyanate or amino type; said piezoelectric heads being supplied with said first and second components, via two separate channels connected to said first and second containers and being operated so as to release said components according to print files having spreading rasters for each channel with coverage in the range of 80-100% so as to perform deposition, in particular in a slightly unfocussed manner, with one or more successive passes by means of a plurality of adjacent droplets; at least two substantially superimposed and uniform layers of the two components which are mixed and intermingle on top of the substrate producing a polymeric chemical reaction by means of polyaddition of the components and subsequent drying of the mixture in order to form a continuous coating film on said substrate.

11. Apparatus according to claim 10, in which said piezoelectric heads are supplied via said channels by means of respective pumps with said components of a dual or multi-component film-forming product, said heads being controlled by a software so as to deposit the component of one head on top of the component of the other head.

12. Apparatus according to claim 10, which comprises discharge tanks which are of a number equal to the number of components and are separate from each other so as to receive said components without mixing them during the cleaning steps or when the printer is inoperative.

13. Apparatus according to claim 10, which envisages two piezoelectric heads for distributing said first component, between which one or more heads for distributing at least said second component are arranged.

14. Apparatus according to claim 13, in which said machine comprises four aligned heads, in particular envisaged for four-colour printing, a first end head of which distributes the first component in transparent form, the second end head distributes the first component in a mat form and the two intermediate heads are able to distribute a second and/or a third component of the mixture.

15. Apparatus according to claim 10, in which the droplets emitted by said piezoelectric heads produce a dot, in particular slightly unfocussed, having an average diameter in the range 0.05-0.35 mm and preferably in the region of 0.15 mm so as to allow correct mixing and intermingling of the components and a rapid polyaddition reaction.

16. Apparatus according to claim 10, in which the distance of the nozzles of the heads from the printing surface are such as to create slightly unfocussed zones of dots and allow the easier intermingling of the fluids in the case where, for stoichiometric reasons, the spatial coverage value drops to values less than 100%.

17. Apparatus according to claim 10, in which the components are distributed with print files having a raster for substantially 100% spreading on the substrate and may be adjusted within the spreading raster for each channel reducing the coverage down to 80%.
